(19) United States
(12) Patent Application Publication
(10) Pub. No.: US 2015/0026561 A1
(43) Pub. Date: Jan. 22, 2015

(54) SYSTEM AND METHOD FOR DISPLAYING WEB PAGE

(71) Applicant: Alpine Electronics, Inc., Tokyo (JP)

(72) Inventors: Haruhiko Nakatsuji, Iwaki (JP); Naoki Saegusa, Iwaki (JP); Rintaro Kuroda, Iwaki (JP)

(73) Assignee: Alpine Electronics, Inc., Tokyo (JP)

(21) Appl. No.: 14/282,728

(22) Filed: May 20, 2014

(30) Foreign Application Priority Data
Jul. 16, 2013 (JP) 2013-148072

(51) Int. Cl. G06F 17/22; G06F 1/16; G06F 3/0488

(52) U.S. Cl. CPC G06F 17/2247; G06F 3/0488; G06F 1/1698
USPC 715/234

(57) ABSTRACT

A system and method for displaying a web page prevents an operation error when the contents of display of the web page change. A vehicle-mounted device includes a touch panel and an input processor for performing an input operation corresponding to a position of contact of an indicator with a display screen. A proximity sensor and an indicator detector detects that the indicator has a predetermined positional relationship relative to the screen. A web browser obtains data on the web page, and a rendering engine performs web page display processing, including web page analysis processing and screen layout calculation for the data obtained. A display processor and a display device for displaying the web page subjected to the web page display processing are included. When the indicator has the predetermined positional relationship relative to the display screen, the web page display processing is stopped.

### PRIORITY CLAIM

This application claims the benefit of Japanese Patent Application No. 2013-148072 filed on Jul. 16, 2013, which is incorporated by reference herein in its entirety.

### FIELD OF THE INVENTION

The present invention relates to a system and method for displaying a web page obtained on the Internet or the like.

### BACKGROUND

A web browser retrieves HTML data from a web server via the Internet, and analyzes display data or display position of text, images, and the like. Then, the display data already analyzed is displayed in turn on a screen. By use of a touch panel, a user can directly touch a display screen (touch panel) with the fingers to issue an instruction directly to a web page displayed.

When the user intends to interact with the web page being displayed through the touch panel before the completion of the analysis of all HTML data by the web browser, an image, such as an advertisement, might be displayed directly before a user's input operation, so that the user then happens to select an area not intended by the user.

On the other hand, a technique for preventing such an operation error on a touch panel by the user's hand is known (see, for example, Japanese Unexamined Patent Publication No. 2012-227819). The technique involves invalidating input of information from the touch panel when a proximity sensor senses the approach of an object.

### SUMMARY

The use of the above-mentioned technique disclosed in Japanese Unexamined Patent Publication No. 2012-227819 can prevent the operation of certain errors on the web page during analysis of HTML data. In this case, however, the touch panel itself cannot be operated during the analysis of the HTML data, which restricts the use of the web page. This cannot take advantage of the inherent operability of the touch panel during the analysis of the HTML data, which does not result in a fundamental solution to the above problem. For this reason, it is desired to develop a technique for preventing the operation error even when the contents of display of the web page change during the analysis of the HTML data.

Embodiments of the present invention have been made in view of the foregoing circumstances, and it is an object of embodiments of the invention to provide a system and method for displaying a web page that can prevent an operation error when the contents of display of the web page change.

In order to solve the foregoing problems, a web page display system for obtaining and displaying a web page according to the invention includes input means for performing an input operation corresponding to a position of contact of an indicator with a display screen; indicator detection means for detecting that the indicator has a predetermined positional relationship with respect to the display screen; obtaining means for obtaining data on the web page; web page display control means for performing web page display processing including web page analysis processing and screen layout calculation for the data obtained by the obtaining means; and display means for displaying the web page subjected to the web page display processing by the web page display control means. When the indicator detection means detects that the indicator has the predetermined positional relationship with respect to the display screen, the web page display control means stops the web page display processing.

A web page display method for obtaining and displaying a web page according to the invention includes the steps of: performing an input operation corresponding to a position of contact of an indicator with a display screen by input means; detecting by indicator detection means that the indicator has a predetermined positional relationship with respect to the display screen; obtaining data on the web page by obtaining means; controlling the display of the web page by using web page display control means to perform web page display processing including web page analysis processing and screen layout calculation for the data obtained in the obtaining step; and displaying, by display means, the web page subjected to the web page display processing by the web page display control means. When the indicator is detected in the indicator detection step to have the predetermined positional relationship with respect to the display screen, the web page display control means stops the web page display processing.

The web page display processing is stopped when detecting the approach of the indicator, so that the screen layout can be fixed after that time. Even when the contents of display of the web page change, the operation error can be prevented.

A web page display system for obtaining and displaying a web page according to the invention includes: input means for performing an input processing corresponding to a position of contact of an indicator with a display screen at the time of the contact; indicator detection means for detecting that the indicator has a predetermined positional relationship with respect to the display screen; obtaining means for obtaining data on the web page; web page display control means for performing web page display processing including web page analysis processing and screen layout calculation for the data obtained by the obtaining means; web page display means for displaying the web page subjected to the web page display processing by the web page display control means; and screen layout storage means for storing therein a first screen layout of a screen displayed when the indicator detection means detects that the indicator has the predetermined positional relationship with respect to the display screen. When a second screen layout provided at the time of contact of the indicator with the display screen is different from the first screen layout stored by the screen layout storage means, the input means performs the input processing using the first screen layout.

A web page display method for obtaining and displaying a web page according to the invention includes the steps of; performing an input processing corresponding to a position of contact of an indicator with a display screen by input means at the time of the contact; detecting by indicator detection means that the indicator has a predetermined positional relationship with respect to the display screen; obtaining data on the web page by obtaining means; controlling the display of the web page by using web page display control means to perform web page display processing including web page analysis processing and screen layout calculation for the data obtained in the obtaining step; displaying, by display means, the web page subjected to the web page display processing by the web page display control means; and storing by screen layout storage means, a first screen layout of a screen displayed when the indicator detection means detects that the indicator has the predetermined positional relationship with respect to the display screen. When a second screen layout provided at the time of contact of the indicator with the display screen is different from the first screen layout stored by the screen layout storage means, the input means performs the input processing using the first screen layout.

When the screen layout obtained upon detecting the approach of the indicator is stored and the screen layout changes after that time, the stored screen layout can be used to perform the input operation. Even when the contents of display of the web page change, the input operation can be performed using the screen layout obtained when the user intends to operate, which can prevent the operation error.

A web page display system for obtaining and displaying a web page according to the invention includes: input means for performing an input processing corresponding to a position of contact of an indicator with a display screen at the time of the contact; indicator detection means for detecting that the indicator has a predetermined positional relationship with respect to the display screen; obtaining means for obtaining data on the web page; web page display control means for performing web page display processing including web page analysis processing and screen layout calculation for the data obtained by the obtaining means; displaying means for displaying the web page subjected to the web page display processing by the web page display control means; and screen layout storage means for storing therein a first screen layout of a screen displayed when the indicator detection means detects that the indicator has the predetermined positional relationship with respect to the display screen. When a second screen layout provided at the time of contact of the indicator with the display screen is different from the first screen layout stored by the screen layout storage means, the input means stops the input processing.

A web page display method for obtaining and displaying a web page according to the invention includes the steps of: performing an input processing corresponding to a position of contact of an indicator with a display screen by input means at the time of the contact; detecting by indicator detection means that the indicator has a predetermined positional relationship with respect to the display screen; obtaining data on the web page by obtaining means; controlling the display of the web page by web page display control means to perform web page display processing including web page analysis processing and screen layout calculation for the data obtained in the obtaining step; displaying, by display means, the web page subjected to the web page display processing by the web page display control means; and storing by screen layout storage means, a first screen layout of a screen displayed when the indicator detection means detects that the indicator has the predetermined positional relationship with respect to the display screen. When a second screen layout provided at the time of contact of the indicator on the display screen is different from the first screen layout stored by the screen layout storage means, the input means stops the input processing.

When the screen layout obtained at the time of detecting the approach of the indicator is stored and the screen layout changes after that time, the input operation can be stopped. Even when the contents of display of the web page change, the operation error due to the use of the screen layout obtained after the change can be prevented.

The above-mentioned input means desirably determines whether the first and second screen layouts are different or the same, based on the contact position of the indicator. Thus, the screen layout other than a point that can cause the operation error can be updated, which can minimize the influence on the display of the web page conventionally performed.

Further, screen layout comparison means is desirably provided for determining whether the above entire first and second screen layouts are different or the same. In this way, the determination is made only by comparing the entire screens of the first and second screen layouts, which can simplify the processing.

The above-mentioned indicator detection means desirably detects the approach of the indicator within less than a predetermined distance from the display screen. When the contents of the web page change after the approach of the indicator to the display screen, the operation error can be prevented.

The above-mentioned indicator detection means desirably detects that the indicator has a predetermined positional relationship upon detecting the contact of the indicator to the specific region of the display screen. Thus, the operation can be performed while updating of the contents of the web page is being stopped. Thus, even when the contents of display of the web page change, the operation error can be surely prevented.

Further, the above-mentioned obtaining means desirably obtains data described in hypertext markup language corresponding to the web page. This arrangement can prevent the operation error in displaying the general web page.

The above-mentioned input means desirably has the touch panel provided on the surface of the display means. The operation error can be prevented in the operation of the web page by use of the touch panel.

The above-mentioned indicator detection means desirably has an infrared sensor for detecting the indicator. Alternatively, the above-mentioned indicator detection means desirably includes a camera for taking an image of the indicator in an imaging range; and an indicator extraction means for extracting the indicator included in the image taken by the camera. This arrangement can detect that the indicator has the predetermined positional relationship with respect to the display screen.

### BRIEF DESCRIPTION OF THE DRAWINGS

FIG. 1 is a diagram showing the structure of a vehicle-mounted device serving as a web page display system according to one embodiment of the invention;

FIG. 2 is a flow chart showing an operation procedure in a first embodiment;

FIG. 3 is an explanatory diagram showing one state of a display screen;

FIG. 4 is an explanatory diagram showing another state of the display screen;

FIG. 5 is an explanatory diagram showing another state of the display screen;

FIG. 6 is a flow chart showing an operation procedure in a second embodiment;

FIG. 7 is an explanatory diagram showing another state of the display screen;

FIG. 8 is a flow chart showing an operation procedure in a third embodiment;

FIG. 9 is a flow chart showing an operation procedure in a fourth embodiment; and

FIG. 10 is a diagram showing a specific region set at a part of the display screen.

### DETAILED DESCRIPTION

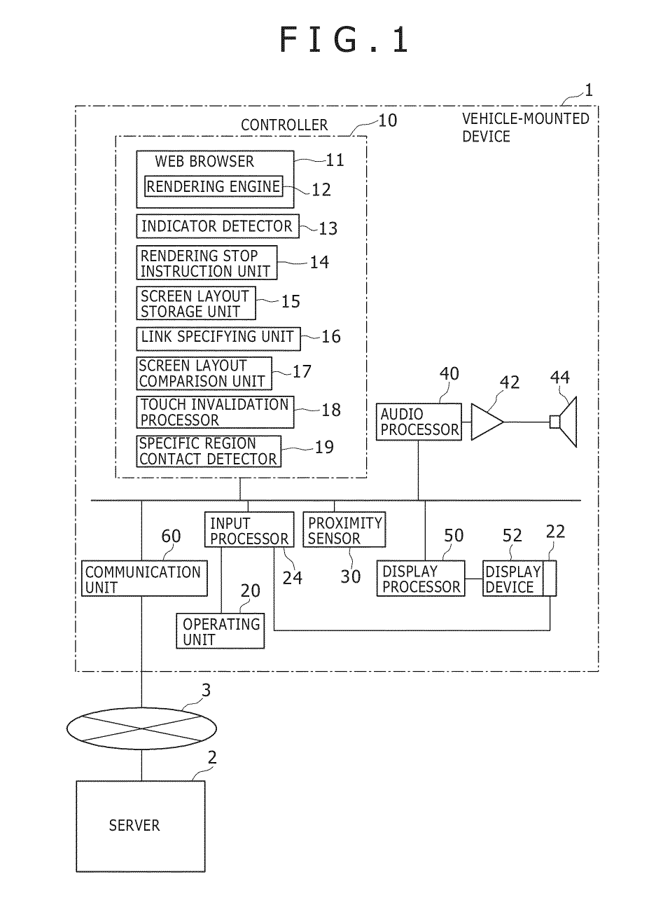

In the following, a vehicle-mounted device to which a web page display system according to one embodiment of the invention is applied, will be described with reference to the accompanying drawings. FIG. 1 shows a diagram of the structure of the vehicle-mounted device as the web page display system of the one embodiment. A vehicle-mounted device 1 of this embodiment is connected to a server 2 via a predetermined network 3.

The network 3 is, for example, the Internet, which is connected to the vehicle-mounted device 1 via a portable phone connected to the vehicle-mounted device 1, or a portable terminal device and a portable base station (both not shown), or which is connected to the vehicle-mounted device 1 via an access point and a communication device (both not shown) for a wireless LAN connected to (or incorporated in) the vehicle-mounted device 1. When connection is available by the wireless LAN, the connection may be established using the wireless LAN. When the connection is not available via the wireless LAN (when there is no nearby access point), the connection may be established using the portable phone or the like.

The server 2 provides a web page to the vehicle-mounted device 1 via the network 3. In general, a plurality of servers 2 are selectively used depending on the types of web pages obtained.

The vehicle-mounted device 1 includes a controller 10, an operating unit 20, a touch panel 22, an input processor 24, a proximity sensor 30, an audio processor 40, an amplifier 42, a speaker 44, a display processor 50, a display device 52, and a communication unit 60.

The controller 10 performs a predetermined operation program using a CPU, a ROM, a RAM, or the like to thereby control the entire operation of the vehicle-mounted device 1, including a displaying operation based on the analysis of the contents of a web page obtained from the server 2 or the result of the analysis thereof. The details of the controller 10 will be described later.

The operating unit 20 is to receive various operations instructed by the user, and includes various switches or operating knobs. The touch panel 22 is disposed to be superimposed over the screen of the display device 52. The touch panel 22 detects the position of contact of an indicator on the screen (which is, for example, a finger of the user, but may be any object suitable for use as an indicator.). The input processor 24 detects the contents input by the user by monitoring the operating states of the operating unit 20 and the touch panel 22.

The proximity sensor 30 detects whether the indicator has a predetermined positional relationship with respect to the display screen of the display device 52. For example, the sensor detects the approach of the indicator at a distance of less than about 5 cm from the display screen. The detection method can employ various existing ways. For example, the detection method may include using an infrared sensor, or using a camera (preferably, a plurality of cameras) for capturing one or more images of the indicator, which image is within an imaging range.

The audio processor 40 is configured to reproduce music data read from a memory or the like (not shown), and to output an audio signal by an audio decoding process for each data format or the like. The audio signal is amplified by the amplifier 42 to be output from the speaker 44.

The display processor 50 is to display various operating screens and web pages under control of the controller 10. The display processor 50 outputs a video signal corresponding to the contents of the display. The video signal is input to the display device 52 to display images. The communication unit 60 serves to transmit and receive various data or to obtain web pages with respect to the server 2 via the network 3. The communication unit 60 performs predetermined processing according to a communication system.

Next, the controller 10 will be described below. As shown in FIG. 1, the controller 10 includes a web browser 11, an indicator detector 13, a rendering stop instruction unit 14, a screen layout storage unit 15, a link specifying unit 16, a screen layout comparison unit 17, a touch invalidation processor 18, and a specific region contact detector 19.

The web browser 11 analyzes and displays the contents of the web page obtained from the server 2. Thus, the web browser 11 includes a rendering engine 12 for performing web page display processing. The web page display processing involves analyzing (performing web page analysis processing) data written by texts for description of web pages (for example, HTML (HyperText Markup Language)), and calculating a screen layout (screen layout calculation) of characters or the like to be displayed on the screen. In this embodiment, in addition to the general operation regarding the display of the web page, the rendering engine 12 performs the operation of “opening a linked page” or “pushing a bottom” when a specific character string exists as a link or bottom during analyzing the HTML source.

The indicator detector 13 detects whether the indicator has a specific positional relationship (at a distance of less than about 5 cm) with respect to the display screen based on an output from the proximity sensor 30. The rendering stop instruction unit 14 sends an instruction to the web browser 11 to stop the web page display processing by the rendering engine 12.

When the indicator detector 13 detects that the indicator has the predetermined positional relationship with respect to the display screen, the screen layout storage unit 15 stores therein a layout of the screen (first screen layout) displayed at that time.

When a layout of the screen (second screen layout) obtained at the time of contact of the indicator with the display screen is different from the first screen layout stored by the screen layout storage unit 15, a specific character string, button, figure, photograph, or the like indicative of a link often exists in the position on the first screen layout corresponding to the position indicated by the indicator. In this case, the link specifying unit 16 specifies the link.

The screen layout comparison unit 17 compares the layout of the screen at the time of contact of the indicator with the display screen (second screen layout), with the first screen layout stored by the screen layout storage unit 15. The comparison operation can be performed only on the position indicated by the indicator, or on the entire area of the screen.

When the layout of the screen at the time of contact of the indicator with the display screen (second screen layout) is different from the first screen layout stored by the screen layout storage unit 15, the touch invalidation processor 18 invalidates (stops) input processing using the touch panel 22. The specific region contact detector 19 detects the contact of the indicator with a specific region on the display screen.

The above-mentioned touch panel 22, input processor 24, link specifying unit 16, and touch invalidation processor 18 correspond to input means. The proximity sensor 30, the indicator detector 13, and the specific region contact detector 19 correspond to indicator detection means. The web browser 11 corresponds to obtaining means. The rendering engine 12 corresponds to web page display control means. The display processor 50 and the display device 52 correspond to display means. The screen layout storage unit 15 corresponds to screen layout storage means. The screen layout comparison unit 17 corresponds to screen layout comparison means.

The vehicle-mounted device 1 of this embodiment has the structure described above, and the operation thereof will be described below.

### First Embodiment

In this embodiment, when the approach of the indicator is detected, the web page display processing performed by the rendering engine 12 is stopped, whereby the screen layout is not changed thereafter.

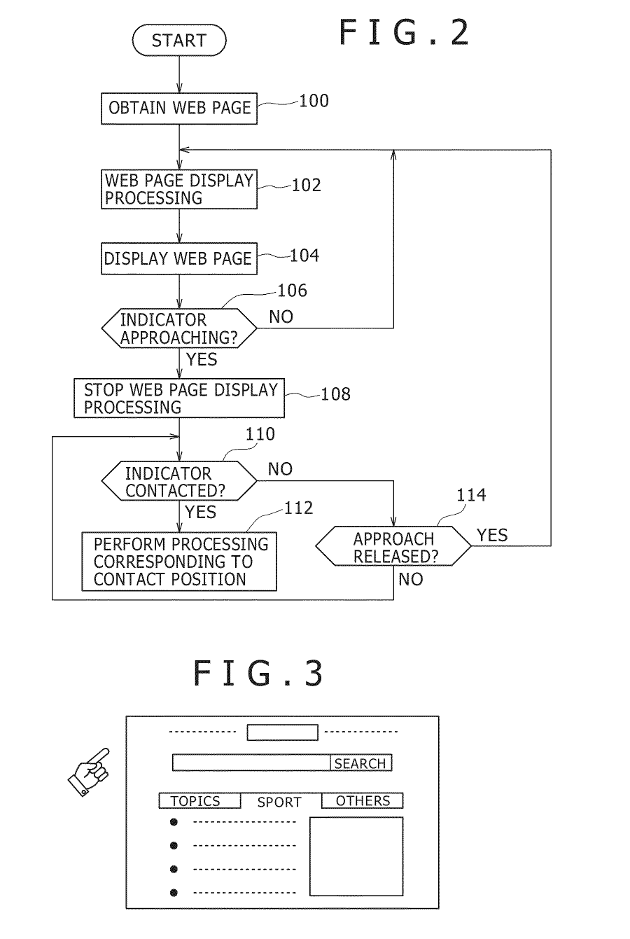

FIG. 2 shows a flow chart of an operation procedure in the first embodiment. When the web browser 11 obtains web page data (for example, HTML data) from the server 2 (in step 100), the rendering engine 12 performs web page display processing (including web page analysis processing, and screen layout calculation) (in step 102), and the display processor 50 displays the web page on the screen of the display device 52 (in step 104).

In conjunction with the operations of steps 102 and 104, the indicator detector 13 determines whether the indicator is approaching or not (whether or not the indicator has a specific positional relationship (at a distance of less than about 5 cm) with respect to the display screen) based on an output from the proximity sensor 30 (in step 106). When the indicator is not approaching, a negative determination is made, in which the web page display processing in step 102 is continued.

When the indicator is approaching, an affirmative determination is made in step 106. Then, a notice of the approaching indicator is sent from the indicator detector 13 to the web blower 11, and the rendering engine 12 stops the web page display processing (in step 108). The stopping operation maintains the screen layout at that time.

The input processor 24 determines whether or not the indicator is brought into contact with the display screen (touch panel 22) (in step 110). When the indicator touches the screen, an affirmative determination is made. Then, the web browser 11 performs the processing according to the contact position (in step 112). In contrast, when the indicator is not in contact with the display screen, the indicator detector 13 determines whether the approach of the indicator is released or not (step 114). When the approach is released, an affirmative determination is made, and the operation returns to step 102, in which the web page display processing is restarted. When the approach is not released, a negative determination is made, and the operation returns to step 110, in which the contact of the indicator with the display screen is repeatedly determined.

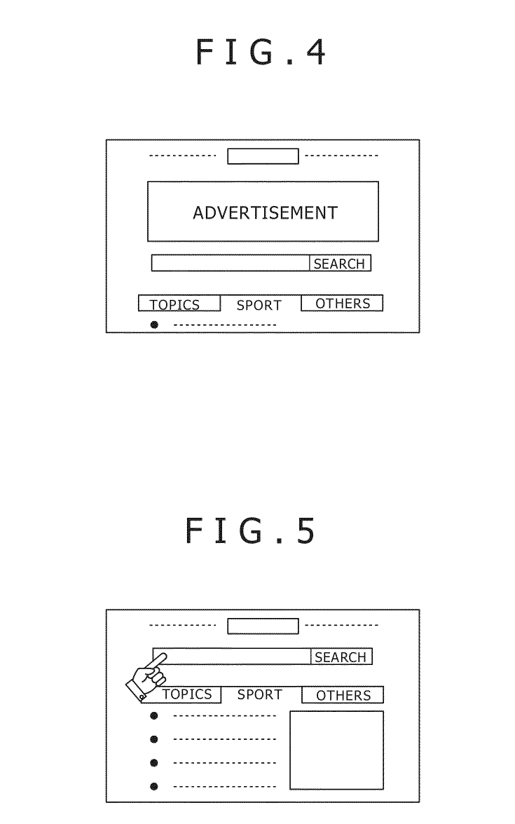

FIG. 3 shows the state in which the indicator is approaching the display screen (an affirmative determination in step 106 of FIG. 2). In general, as shown in FIG. 4, when this state is left behind, an “advertisement” or the like can be inserted into the position unexpected by the user with the progress of the web page display processing. In contrast, in this embodiment, as shown in FIG. 5, the web page display processing thereafter is stopped, so that the screen layout at that time is maintained. Thus, the user can accurately and directly touch a display element (in a search box shown in FIG. 5) included in the screen layout maintained before the display element changes with the finger together with the progress of the web page display processing.

In this way, the vehicle-mounted device 1 of this embodiment is adapted to stop the web page display processing when detecting the approach of the indicator, so that the screen layout can be fixed after that time. Accordingly, an operation error can be prevented when the contents of display of the web page change.

It is detected that the indicator is approaching within less than a predetermined distance from the display screen. Thus, even when the contents of the web page are changed after the indicator approaches the display screen, the operation error can be prevented. Data described by the HTML is obtained corresponding to the web page, which can prevent the operation error in displaying the general web page. The operation error can be surely prevented in the operation of the web page by use of the touch panel 22.

### Second Embodiment

In this embodiment, a screen layout is stored at the time when the approach of the indicator is detected, and at the same time the analysis processing of a web page is continued. Thereafter, when the indicator touches the display screen with the screen layout being changed, the screen layout previously stored is used to perform the processing.

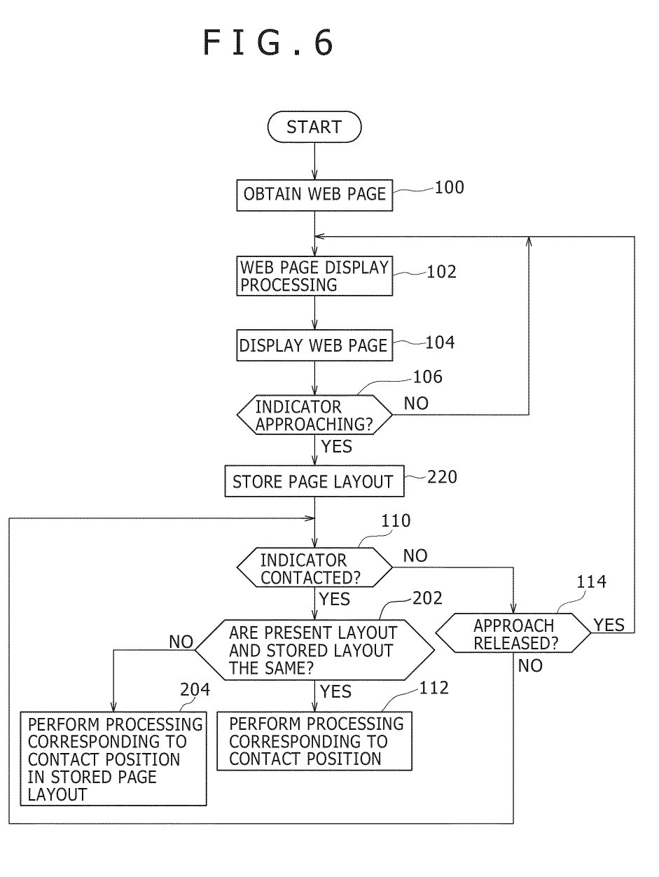

FIG. 6 shows a flow chart of an operation procedure in a second embodiment. The operations which are basically the same as those shown in FIG. 2 are designated by the same reference characters. In the following, main different points in the operation procedure therebetween will be described.

When the indicator is approaching and an affirmative determination is made in step 106, then the screen layout storage unit 15 stores the screen layout (first screen layout) at that time (in step 200). At this time, the web page analysis processing by the rendering engine 12 is continued.

Then, the input processor 24 determines whether or not the indicator is brought into contact with the display screen (touch panel 22) (in step 110). When the indicator touches the screen, an affirmative determination is made. Then, the screen layout comparison unit 17 determines whether or not a screen layout (second screen layout) obtained at the time of contact is the same as the screen layout (first screen layout) stored (in step 202). When these screen layouts are the same, an affirmative determination is made, and the web browser 11 performs processing corresponding to the contact position (in step 112). In contrast, when the first and second screen layouts are different from each other, a negative determination is made in step 202. In this case, when a specific character string, button, figure, photograph, or the like indicative of a link exists in the position on the first screen layout corresponding to the position indicated by the indicator, the link specifying unit 16 indicates the link. Then, the web browser 11 performs the processing according to the contact position using the stored first screen layout (in step 204).

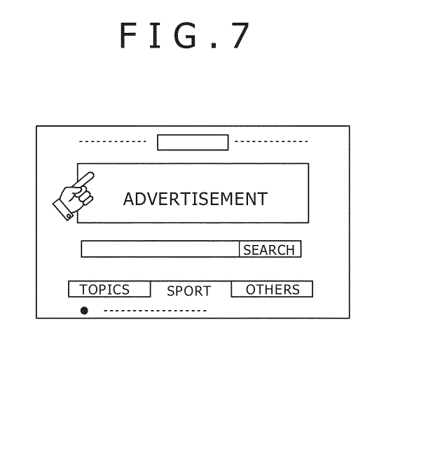

For example, even when the “advertisement” is inserted upon the contact of the user's finger with the display screen as shown in FIG. 7, a search box can be specified or designated in the same way as that shown in FIG. 5, provided that the screen layout is stored as shown in FIG. 3. When the link exists in the position on the first screen layout indicated by the user's finger, the web page of the link specified by the link specifying unit 16 may be obtained by the web browser 11. In contrast, when no link exists in the position, the first screen layout stored is desirably started and displayed again.

As mentioned above, the vehicle-mounted device 1 of this embodiment can store the screen layout at that time upon detecting the approach of the indicator, and can perform an input operation using the stored screen layout when the screen layout obtained after that time changes. Thus, even when the contents of display of the web page change, the input operation can be performed using the screen layout obtained at the time when the user intends to operate, which can prevent the operation error.

Whether the first and second screen layouts are different or the same can be determined based on the contact position of the indicator, thereby updating the screen layout other than a point that might cause the operation error, which can minimize the influence on the display of web pages conventionally performed. Alternatively, whether the first and second screen layouts are different or the same is determined only by comparing the entire screens of both the screen layouts, which can simplify the processing.

### Third Embodiment

In this embodiment, a screen layout is stored at the time when the approach of the indicator is detected, and at the same time the web page analysis processing is continued. Thereafter, when the screen layout is changed upon the touch of the indicator on the display screen, the input operation using the touch panel 22 is stopped (invalidated).

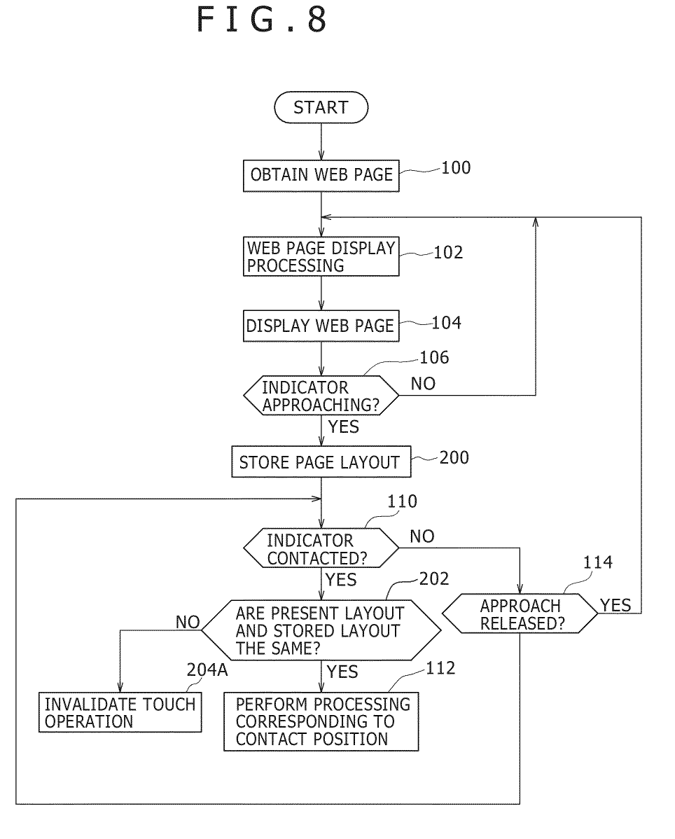

FIG. 8 shows a flow chart of an operation procedure in a third embodiment. The operation procedure shown in FIG. 8 differs from that shown in FIG. 6 in that the step 204 is replaced by a step 204A. In the following, the third embodiment will be described below based on this difference.

When the first and second screen layouts are different, leading to a negative determination in step 202, the touch invalidation processor 18 gives the input processor 24 (or web browser 11) an instruction to invalidate the touch operation. Thereafter, the input operation using the touch panel 22 is stopped (step 204A).

As mentioned above, the vehicle-mounted device 1 of this embodiment can store the screen layout at the time of detecting the approach of the indicator, and can stop the input operation when the screen layout changes after that time. Even when the contents of display of the web page change, the vehicle-mounted device 1 of this embodiment can prevent the operation error due to the use of the screen layout after the change.

### Fourth Embodiment

Although in the first embodiment, the web page display processing is stopped upon detecting the approach of the indicator using the proximity sensor 30, in this embodiment, the web page display processing is stopped upon touch of the indicator on a specific region of the display screen.

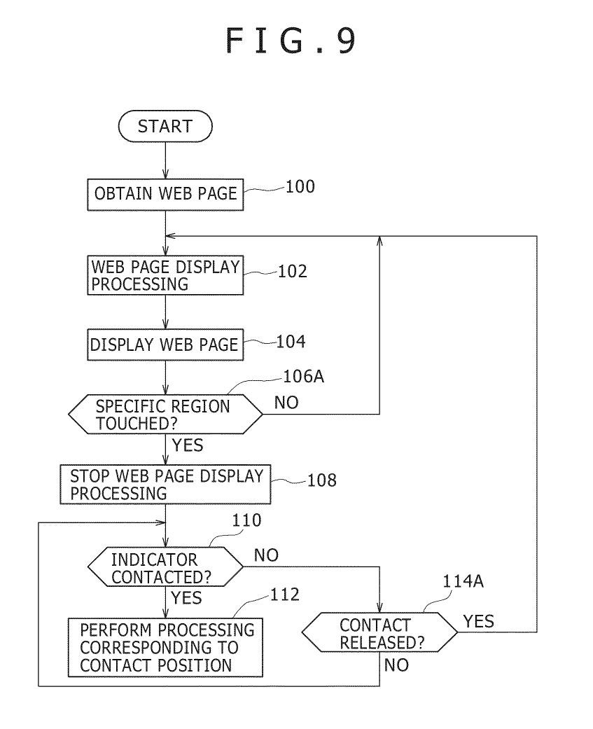

FIG. 9 shows a flow chart of an operation procedure in a fourth embodiment. The operation procedure shown in FIG. 9 differs from that shown in FIG. 2 in that the step 106 is replaced by a step 106A and that the step 114 is replaced by a step 114A. In the following, the operation procedure of this embodiment will be described below based on these differences.

In conjunction with the operations of steps 102 and 104, the specific region contact detector 19 determines whether or not a specific region within the display screen is touched by the indicator (with the user's hand) (in step 106A). When the specific region is not touched, a negative determination is made, in which the web page display processing in step 102 is continued.

When the specific region is touched by the indicator, an affirmative determination is made in step 106A. Then, a notice of the touch of the indicator is sent to the web browser 11 from the specific region contact detector 19, whereby the rendering engine 12 stops the web page display processing (in step 108).

When the indicator does not touch the display screen and a negative determination is made in step 110, the specific region contact detector 19 determines whether the touch of the indicator in the specific region is released or not (in step 114A). When the touch is released, an affirmative determination is made, and the operation returns to step 102, in which the web page display processing is restarted. When the touch of the specific region is not released, a negative determination is made, and the operation returns to step 110, in which the determination of the contact on the display screen is repeated.

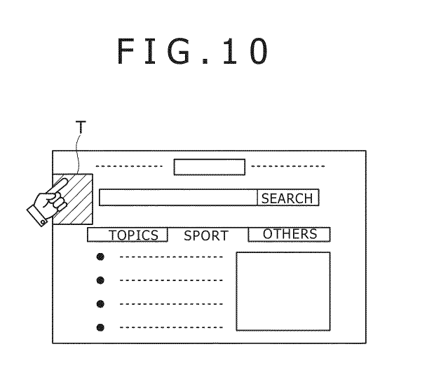

FIG. 10 shows a diagram of a specific region set at a part of the display screen. The specific region is desirably provided in such a position as not to interrupt the display of the web page included in the display screen. In the example shown in FIG. 10, the specific region T is disposed on the upper left side of the display screen.

The operation of stopping the web page display processing is maintained while the specific region is being touched by the indicator. Thus, the touch of the indicator in a desired position on the display screen with the screen layout maintained (fixed) needs to be performed while the specific region is being touched. Thus, the multi-touch panel 22 that can simultaneously detect a plurality of touch points and the input processor 24 need to be used.

In this way, the vehicle-mounted device 1 of this embodiment can perform the operation on the web page while stopping updating of the contents of the web page by touching the specific region, which can surely prevent the operation error when the contents of display of the web page change.

The present invention is not limited to the above-mentioned embodiments, and various modifications and changes can be made to the embodiments within the scope of the invention. For example, in the above embodiments, the invention is applied to the case where the vehicle-mounted device is used to display the web page. Alternatively, the present invention can be applied to the display of web pages using a desktop or laptop PC (personal computer) or tablet personal computer.

As described above, according to the invention, the web page display processing is stopped upon detecting the approach of the indicator, which can fix the screen layout after that time. Accordingly, the operation error can be prevented when the contents of display of the web page change.

Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. A web page display system for obtaining and displaying a web page, comprising:
an input unit configured to perform an input operation corresponding to a position of contact of an indicator with a display screen;
an indicator detection unit configured to detect that the indicator has a predetermined positional relationship with respect to the display screen;
an obtaining unit configured to obtain data on the web page;
a web page display controller configured to perform web page display processing, including web page analysis processing and screen layout calculation for the data obtained by the obtaining unit;
a display unit configured to display the web page subjected to the web page display processing by the web page display controller; and
wherein when the indicator detection unit detects that the indicator has the predetermined positional relationship with respect to the display screen, the web page display controller stops the web page display processing.

2. A web page display system for obtaining and displaying a web page, comprising:
an input unit configured to perform an input processing corresponding to a position of contact of an indicator with a display screen at the time of the contact;
an indicator detection unit configured to detect that the indicator has a predetermined positional relationship with respect to the display screen;
an obtaining unit configured to obtain data on the web page;
a web page display controller configured to perform web page display processing, including web page analysis processing and screen layout calculation for the data obtained by the obtaining unit;
a web page display unit configured to display the web page subjected to the web page display processing by the web page display controller;
a screen layout storage unit configured to store therein a first screen layout of a screen displayed when the indicator detection unit detects that the indicator has the predetermined positional relationship with respect to the display screen; and
wherein, when a second screen layout provided at the time of contact of the indicator with the display screen is different from the first screen layout stored by the screen layout storage unit, the input unit performs the input processing using the first screen layout.

3. A web page display system for obtaining and displaying a web page, comprising:
an input unit configured to perform an input processing corresponding to a position of contact of an indicator with a display screen at the time of the contact;
an indicator detection unit configured to detect that the indicator has a predetermined positional relationship with respect to the display screen;
an obtaining unit configured to obtain data on the web page;
a web page display controller configured to perform web page display processing, including web page analysis processing and screen layout calculation for the data obtained by the obtaining unit;
a display unit configured to display the web page subjected to the web page display processing by the web page display controller;
a screen layout storage unit configured to store therein a first screen layout of a screen displayed when the indicator detection unit detects that the indicator has the predetermined positional relationship with respect to the display screen; and
wherein, when a second screen layout provided at the time of contact of the indicator with the display screen is different from the first screen layout stored by the screen layout storage unit, the input unit stops the input processing.

4. The web page display system according to claim 3, wherein the input unit determines whether the first and second screen layouts are different, based on the contact position of the indicator.

5. The web page display system according to claim 3, further comprising a screen layout comparison unit configured to determine whether the entire first and second screen layouts are different.

6. The web page display system according to claim 3, wherein the indicator detection unit detects approach of the indicator within less than a predetermined distance from the display screen.

7. The web page display system according to claim 1, wherein when the indicator detection unit detects that the indicator contacts a specific region of the display screen, the indicator detection unit determines that the indicator has the predetermined positional relationship.

8. The web page display system according to claim 1, wherein the obtaining unit obtains data described in hypertext markup language corresponding to the web page.

9. The web page display system according to claim 1, wherein the input unit includes a touch panel provided on a surface of the display unit.

10. The web page display system according to claim 1, wherein the indicator detection unit includes an infrared sensor configured to detect the indicator.

11. The web page display system according to claim 1, wherein the indicator detection unit includes a camera for capturing an image of the indicator in an imaging range; and
an indicator extraction unit configured to extract the indicator included in the image captured by the camera.

12. A web page display method for obtaining and displaying a web page, comprising the steps of:
performing an input operation corresponding to a position of contact of an indicator with a display screen by an input unit;
detecting, by an indicator detection unit, that the indicator has a predetermined positional relationship with respect to the display screen;
obtaining data on the web page by an obtaining unit;
controlling the display of the web page by a web page display controller, to perform web page display processing including web page analysis processing and screen layout calculation for the data obtained in the obtaining step;
displaying, by a display unit, the web page subjected to the web page display processing by the web page display controller; and
wherein, when the indicator is detected to have the predetermined positional relationship with respect to the display screen, the web page display controller stops the web page display processing.

13. A web page display method for obtaining and displaying a web page, comprising:
performing input processing corresponding to a position of contact of an indicator with a display screen, by an input unit at the time of the contact;
detecting, by an indicator detection unit, that the indicator has a predetermined positional relationship with respect to the display screen;
obtaining data on the web page by an obtaining unit;
controlling the display of the web page by a web page display controller, to perform web page display processing, including web page analysis processing and screen layout calculation for the data obtained in the obtaining step;
displaying, by a display unit, the web page subjected to the web page display processing by the web page display controller;
storing by a screen layout storage unit, a first screen layout of a screen displayed when the indicator detection unit detects that the indicator has the predetermined positional relationship with respect to the display screen; and
wherein, when a second screen layout provided at the time of contact of the indicator with the display screen is different from the first screen layout stored by the screen layout storage unit, the input unit performs the input processing using the first screen layout.

14. A web page display method for obtaining and displaying a web page, comprising:
performing input processing corresponding to a position of contact of an indicator with a display screen by an input unit at the time of the contact;
detecting, by an indicator detection unit, that the indicator has a predetermined positional relationship with respect to the display screen;
obtaining data on the web page by an obtaining unit;
controlling the display of the web page by a web page display controller to perform web page display processing, including web page analysis processing and screen layout calculation for the data obtained in the obtaining step;
displaying, by a display unit, the web page subjected to the web page display processing by the web page display controller;
storing, by a screen layout storage unit, a first screen layout of a screen displayed when the indicator detection unit detects that the indicator has the predetermined positional relationship with respect to the display screen; and
wherein, when a second screen layout provided at the time of contact of the indicator with the display screen is different from the first screen layout stored by the screen layout storage unit, the input unit stops the input processing.
